(19) United States
(12) Patent Application Publication
(10) Pub. No.: US 2014/0160288 A1
(43) Pub. Date: Jun. 12, 2014

(54) SECURITY MONITOR

(71) Applicants: SERGEI MAKAVEEV, TORONTO (CA); MIKALAI PUTSEYEU, VITEBSK (BY); ULADZIMIR PUTSEYEU, VITEBSK (BY); PAVEL MAKAVEEV, TORONTO (CA)

(72) Inventors: SERGEI MAKAVEEV, TORONTO (CA); MIKALAI PUTSEYEU, VITEBSK (BY); ULADZIMIR PUTSEYEU, VITEBSK (BY); PAVEL MAKAVEEV, TORONTO (CA)

(21) Appl. No.: 13/711,523

(22) Filed: Dec. 11, 2012

(51) Int. Cl. H04N 7/18

(52) U.S. Cl. CPC H04N 7/18
USPC 348/148; 348/143

(57) ABSTRACT

The invention provides an improve security of a vehicle, resident of houses, office workers, data and property. It consists of software, controllers, sensors, recording and communication devices, filing video, audio and other signals, recording and recognizing devices; thus in addition contains at least one control object, or at least one control action, or their combination.

The security system assists in protection from the actions under control of the criminal for example when user hold on a gun point during the process of disabling an alarm, system simulate normal operation but in fact, new method switches security system to a standby mode and awaits of a presentation of the control object or an action confirming that there is no danger for the user; for example if enter his or her office under the supervision of the offender.

After this actions security system can be switched off or put on monitoring mode.

Aspects of the invention concern security such as vehicles, apartments, houses, offices, data and others. System is developed so that it increases user's safety during the process of access to the object and after, as well as securing of a property.

### PRIOR LEVEL OF TECHNICS

Common security systems are used prevent unauthorized takeover or entry.

It uses a variety of devices, codes, communication modes, users' physical data, etc. After it matched an entered code, system grants access to the secured object.

Patent <<Security control system>> (U.S. Pat. No. 4,755,792, date of patent: Jul. 5, 1988) indicates that the controller is programmed to transmit disarm signal only upon entry of a secret user-selected code.

Patent <<Distributed monitoring for a video security system>> (U.S. Pat. No. 7,015,806 B2, date of patent: Mar. 21, 2006) provides security gateway which detects alarm conditions at a premises and records video relating to the alarm condition.

Patent <<Vehicle anti-theft device>> (U.S. Pat. No. 5,644,172, date of patent: Jul. 1, 1997) describes anti-theft device includes a plurality of control units electrically coupled between the vehicle electrical system and vital electrical components of the vehicle for controlling the delivery of power to these components. The control units normally interrupt power to these components but provide a path of power upon receiving an activation signal. The control units are directly coupled between the vehicle electrical system and the controlled electrical components and are powered by the vehicle electrical system. The anti-theft device also includes a transmitter device for transmitting an activation signal to the control units. When the control units receive this signal, they switch power to their respective components to allow their operation. The signal transmitted by the transmitter device is an audio frequency signal or a low power FM broadcast signal which is not widely broadcast remote from the vehicle.

Patent <<Vehicle anti-theft device>> uses both electromagnetic induction and frequency modulation transmission of power and data (U.S. Pat. No. 6,011,320, date of patent: Jan. 4, 2000) provides a key entry system having redundant communication between the IC card and the vehicle controller to ensure continuous operation. The ID card and the vehicle controller each includes a memory for storing an ID code, an electromagnetic induction power supply/transmission circuit for transmitting and receiving the ID code and an RF modem also for transmitting and receiving the ID codes. Thus, in the event that communication cannot be made between the RF modems, the key entry system will still function by communication between the electromagnetic induction power supply/transmission circuits.

Patent <<Vehicle security system>> (U.S. Pat. No. 6,608,555 B1, date of patent Aug. 19, 2003) offers vehicle security system that includes a detector circuit cluster, an alarm circuit cluster and a host device, all connected to a common power supply line. The detector circuit cluster includes a detector circuit for detecting a current state of a respective component of the vehicle. The detector circuit can receive a status request signal and transmit a status response signal corresponding to the detected state of the respective component. The alarm circuit cluster is enabled upon receipt of an alarm enable signal for generating an alarm output. The host device can transmit the status request signal for the detector circuit, receive the status response signal from the detector circuit, and selectively transmit the alarm enable signal in accordance with the status response signal.

Patents <<Security control system>> (U.S. Pat. No. 4,755,792, date of patent: Jul. 5, 1988), <<Workspace security system>> (U.S. Pat. No. 6,965,294 BF, date of patent: Nov. 15, 2005), <<Security system user interface>> (U.S. Pat. No. 7,046,142 B2, date of patent: May 16, 2006), <<Security system>> (U.S. Pat. No. 7,046,985 B2, date of patent: May 16, 2006), <<Security confirmation system and method thereof>> (U.S. Pat. No. 7,227,461 B2, date of patent: Jun. 5, 2007), <<Method and apparatus for interfacing security systems by periodic check in with remote facility>> (U.S. Pat. No. 7,292,142 B2 Nov. 6, 2007, date of patent: Nov. 6, 2007), <<Method and apparatus for interfacing security systems by periodic check in with remote facility>> (U.S. Pat. No. 7,633,388 B2, date of patent: Dec. 15, 2009), <<Security system>> (U.S. Pat. No. 7,847,675 BF, date of patent: Dec. 7, 2010) describe the different compositions and methods of security and monitoring system.

Any mentioned systems and methods of their operation that listed above do not provide protection for the user. As in situation when user got under duress of a criminal during the process of disabling an alarm or in situation when user was attacked by someone. For example, very common situation when car have been hijacked after it was disarmed.

Accordingly, there is a need in security system that would provide protection for such type of crimes. It is also desirable to have a feature that would protect user or an operator.

### ESSENCE OF AN INVENTION

The security system in a various combination consists of controllers, processors, sensors, protected contours, recording and identifying devices, communication devices, transmit video, audio and other signals.

Applying a different kinds of listed above features can form a various types of security system for the vehicles, houses, offices, data or other object, thus in addition contains at least one control object, or at least one control action, or their combination, entered into systems memory.

The effectiveness of any security system depends on how its operations can be observed by an unauthorized person, especially if these individual plan an attack or seizure.

In proposed system has been included special objects (e.g. key card) or command (e.g. voice command, gesture, etc.) entered by the user, system's manufacturer or another authorized party before running system. Also replacement of the control object or command is possible by listed above parties during the operation of the system.

When disarming system by any known methods such as remote control, enter code, scan fingerprint, etc., security system simulate normal operation without causing an outsider to become suspicious. In reality, a new method of functioning puts security system on hold and awaits till user make control command, confirming that there is no danger for the user.

Example of such situation would be when user entered a house under duress. In home security system such action can be mandatory within a specified period of time; for example, after closing the door user inside the building demonstrates in front of a video camera special object, or scan the fingerprint or retina, or pronouncing code word or sound or any other actions, entered into the system by user. After this action system can ether turned off or switched on to monitoring mode.

Such actions, if possible, should not be observed by strangers during the work with the system, to prevent an outsider from acquiring information on additional measures of protection.

In monitoring mode system, if user repeats control command or action, system will automatically contact local police station, or private security company, or make signals that will attract attention or any other action. Such signal for the communication with the system may be a repetition of the same control command while the alarm is set to monitoring mode or anything else.

In a car alarm, system associate its actions to the position of the ignition key, engine status (running-not running), tilt sensors, suspension, the presence of speed or other information to avoid towing, loading, movement or other action of an unauthorized disposal of a vehicle. For example, driving a car without providing control command, system will stop engine, start an alarm or speaker of the security system which could pronounce a phrases such as “Police, I was hijacked” in the preinstalled language (s) by the user. Also security system control command mode will contact with the local police station, or private security company, or give a signal that should attract attention, etc.

Thus system can perform an action like contact local police station, or private security company, or give a signal, etc., unnoticeably located in the home, car, etc., for example by applying a fingerprint of the left hand instead of right, the engine will start and car will be able to move; however, after a certain time period vehicle will stop.

When protecting date, absence of the control command, or performing special command, system will block access to the information or date. Thus the system can generate control command while working let's say for the next hour and report them to the user.

Also system can work together, or in the connection with other security devices, such as satellite detection and tracing coordinates of a stolen vehicle.

Also system has a “dangerous occurrence” mode in which recorded images of persons entitled to access images and objects that pose a threat, such as weapons. When user activates this function, including during monitoring mode, security system detects as a foreigner or threat and takes action specified by user.

1. House, office, vehicles, data and other objects of a security system which containing in a various combination a software, controllers, processors, memory, sensors, protected contours, video, audio other recording and recognising devices as well as recording devices, communicating device, devices of arming and disarming system and, submission of video, audio and other signals, in a addition containing at least one control object or control action, or their combination, entered into system's memory by user, system's manufacturer or other authorized person prior to the beginning of maintenance of a system with possibility of its replacement.

2. Protection system defined in paragraph 1, created with the ability of warning user about approaching expiration time period to present a control object or action.

3. Method of operating of a security system, according to which:
a) After disarming the system, it starts to simulate normal operation and grants temporary access; however, in reality system switches alarm on standby mode and awaits from the user to present control object or action which will prove whether the user deactivated system under the thread of duress.
b) During a specified time or some user activity, system waits for the input, for example a demonstration of a control object in front of a camera or pronunciation of a code word or any other action or combination of actions which are pre-entered by user or manufacturer, or any other authorized person.
c) After completing B part, security system either disables itself or switches to monitoring mode.
d) After expiry of pre-set period of time without conformation of control object or action system will perform an action on secured object (e.g. switch vehicle's engine off)
e) In the absence of the conformation of control action or object security system, for instance, is capable to contact with a police or Security Company or other pre-installed actions.

4. Method in paragraph 3, whereby presenting presentation of the control action or command in monitoring mode system can contact with the police or security company, or signal to attract attention, etc.

5. Method in paragraph 3, according to which security system synchronizes its actions with a position of a key in the ignition, engine status (running-not running), the tilt sensor in the vehicle, suspension, presence of speed or other information so that system excluded towing, loading, moving or other unauthorized occupation of the vehicle.

6. Method according to paragraph 5 whereby during car driving without proper submission of the control command or object during specific time period security system disables car engine.

7. Method according to paragraph 5, whereby after the start of a vehicle without proper submission of the control command or object during specific time period security system automatically applies brakes or other vehicle's systems that exclude any movement.

8. Method according to paragraphs 6, 7, whereby after the start of a vehicle without proper submission of the control command or object during specific time period security system stops vehicle with controlled deceleration.

9. Method in paragraph 5, according to which system switched on vehicle's alarm system and speaker can say phrases such as “Police, I was hijacked” in the preinstalled language(s).

10. Method in paragraph 3, according after the start of a vehicle without proper submission of the control command or object during specific time period security system performs an action that should attract an attention, such as switching on of the hidden lights or sound signals.

11. Method according to paragraph 10, according to which security system can signal to attract attention and others, and will be indiscernible from inside of the object.

12. Method in paragraph 3, according to which system during operation period can generate control commands or objects, for instance for the next hour and used them for security purposes.

13. Method in paragraph 3, according to which security system for control action or command in a car, house, control elements or other can use equipment, such as radio, gear shifter and other.

14. Method in paragraph 3, according to which after disabling security system, resubmission of a control object or action shifts system to panic mode as well as contacts nearest police station, private security company or other.

15. Method in paragraph 14, according to which if desired security system can be immediately put on alert, or with a temporary delay.

16. Method in paragraph 3, according to which submission of a control actions or command can be repeated more than once.

17. Method in paragraph 3, according to which if during monitoring mode of an object security system detects left behind children, animals makes an attempt to maintain the life support system, and (or) activates alarm mode.

18. Method in paragraph 3, according during the process of submission of control object or action system can inform user about upcoming expiration period of time by coordinated or open direct method.

19. Method in paragraph 3, according submission of more than one control object or action or their combination is separated by priority.

20. Method in paragraph 19, according to which second or more control object and/or action, or their combination can be used limited number of times.
